(19) United States
(12) Patent Application Publication
(10) Pub. No.: US 2015/0012642 A1
(43) Pub. Date: Jan. 8, 2015

(54) METHOD AND SYSTEM FOR MONITORING INDEPENDENT INVENTORIES STATUS

(71) Applicant: Verizon Patent and Licensing Inc., Basking Ridge, NJ (US)

(72) Inventors: Robert A. Keene, Luray, VA (US); Doug L. Wekamp, Colorado Springs, CO (US); Connie A. Coffey, Gainesville, VA (US); Kavita G. Deshmukh, Fairfax, VA (US)

(21) Appl. No.: 13/936,940

(22) Filed: Jul. 8, 2013

(51) Int. Cl. H04L 12/26

(52) U.S. Cl. CPC H04L 43/04
USPC 709/224

(57) ABSTRACT

An approach for enabling a monitoring system to immediately identify different types of transactions that occur within a service provider network is disclosed. A proactive monitoring system receives a notification of a change of status of at least one of a plurality of assets provisioned within a network of a service provider. The proactive monitoring system also generates an audit record based on the data independent of one or more transaction classifications, whether the change of status is related to a transaction performed by the service provider, or a combination thereof.

### BACKGROUND INFORMATION

Typically, telecommunication service providers employ a number of disparate provisioning systems for managing the allocation and use of the various network components within their network inventory. Oftentimes, telecommunication service providers acquire the provisioning and inventory systems from other providers as a means of expanding their network or entering new territories. Unfortunately, the acquired systems often require different types of data or perform transactions in a manner unique to the original network environment from which they came.

Still further, in cases where an unscheduled or off-network transaction is performed, a monitoring system of the service provider may not be able to identify the transaction. This results in discrepancies being determined as the monitoring system is unable to account for the different transaction types that are performed within the system at any given moment. Moreover, the service provider is limited in their ability to handle such discrepancies given the lack of parity between the native and acquired systems.

Based on the foregoing, there is a need for enabling a monitoring system to immediately identify different types of transactions that occur within a service provider network.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system for identifying different types of transactions that occur within a service provider network, according to various embodiments;

FIG. 1B is a diagram of a proactive monitoring system for interacting with one or more subsystems of a service provider network, according to one embodiment;

FIG. 2 is a diagram of a proactive monitoring system of FIGS. 1A and 1B, according to one embodiment;

FIGS. 3A and 3B are flowcharts of processes for enabling a monitoring system to immediately identify different types of transactions that occur within a service provider network, according to various embodiments;

FIGS. 4A and 4B are diagrams of user interfaces rendered by the system of FIGS. 1A and 1B, according to various embodiments;

FIG. 5 is a diagram of a computer system that can be used to implement various exemplary embodiments.

### DESCRIPTION OF THE PREFERRED EMBODIMENT

An apparatus, method, and software for analyzing data generated by multiple monitoring systems to validate the status of various assets of a service provider network, such as maintained by a telecommunications service provider for example, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to the coordinating of disparate systems, it is contemplated that these embodiments have applicability to systems operated by different organizations and to other operations wherein asset inventory information may be maintained in separate subsystems.

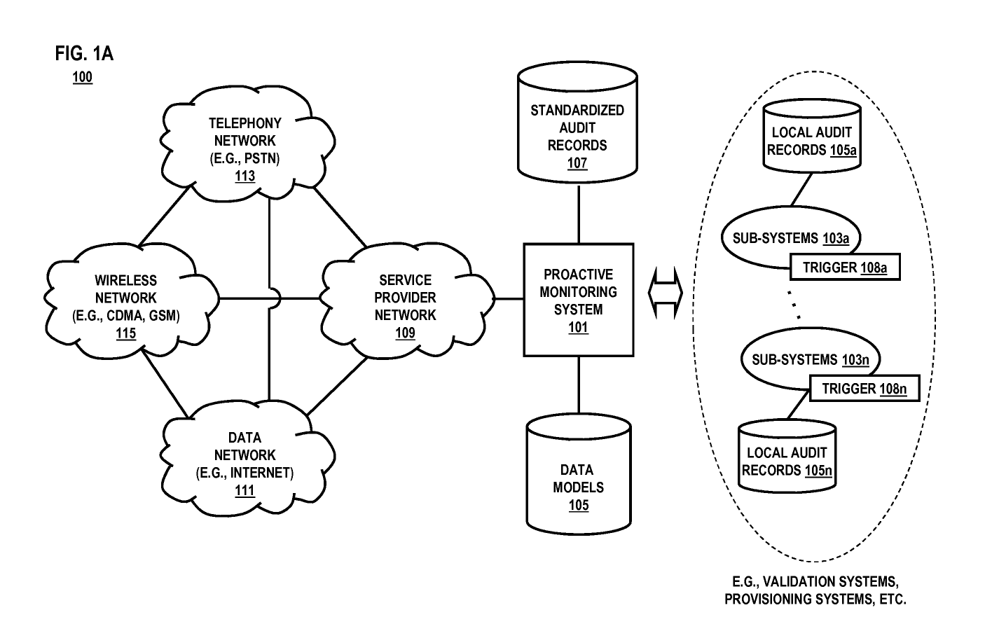

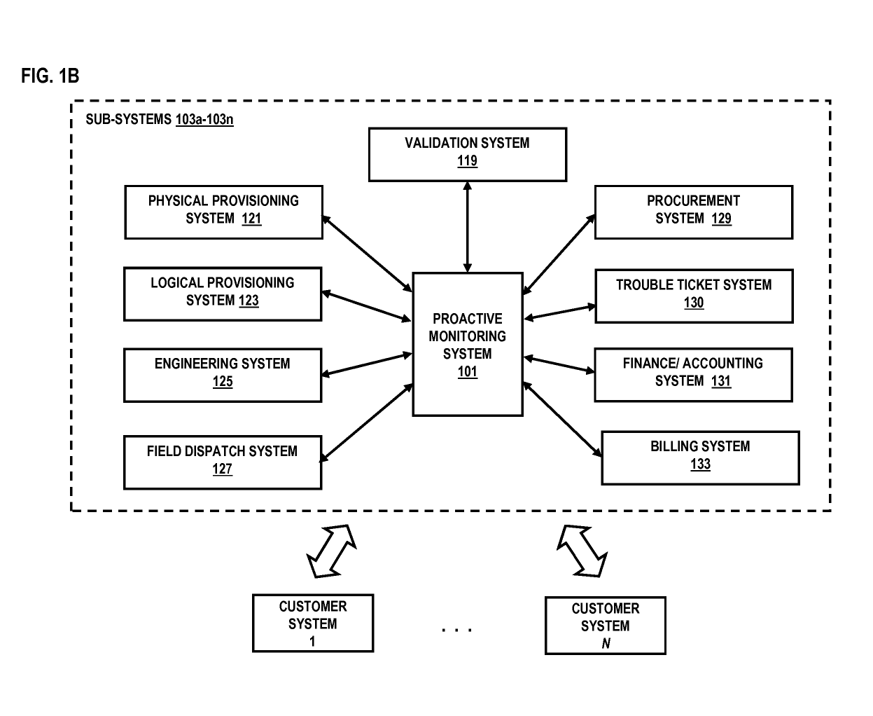

FIGS. 1A and 1B are diagrams of a system for enabling a monitoring system to immediately identify different types of transactions that occur within a service provider network, according to various embodiments. Service providers and other businesses may utilize several approaches to obtain accurate inventory information, including using a number of different provisioning systems and other asset/inventory management tools. Provisioning systems may include, for example, any tool (software) for informing the service provider of the current allocation or use of a particular arrangement of network components, or circuits, within the telecommunication network. For the purpose of illustration, the circuits represent a portion of the assets of the service provider; wherein the provisioning system may need to observe the status of orders, channels and bandwidth utilization related to said circuits. In addition, the provisioning system may indicate the current allotment of channels within a given circuit for enabling fulfillment of specific customer orders or communication tasks. Various other tools, including status monitoring systems and other tools, may also be employed for enabling accurate monitoring of the various assets and/or transactions associated therewith.

Usually, the different systems for provisioning or monitoring are introduced to the service provider network as a result of acquisition or expansion. For example, in response to growing capacity requirements or customer needs, it is common for service providers to acquire additional network components to add to their existing telecommunication network. The acquired assets are often configured with different systems and sub-systems, all of which may process and convey data according to different data structures. Thus, there are discrepancies between the data and results returned by the different systems relative to the same assets or channels as provisioned. Still further, in cases where an unscheduled or off-network transaction is performed (e.g., a transaction that is anomalous to the workflow), the monitoring system is unable to identify the transaction. Resultantly, the monitoring system is unable to immediately provide the service provider with relevant data regarding all transaction types that may occur at any given moment.

To address this issue, system 100 includes a proactive monitoring system 101 that interacts with a multitude of sub-systems (or data systems) 103a-103n to collect inventory data and status data relating to assets owned and/or managed by the service provider. For the purpose of illustration herein, any data regarding the status of an asset, a particular procedure or transaction performed with respect to the asset, or a combination thereof is referred to herein as change of status data. It is noted that the change of status data may indicate current or expected channel allocations, network (e.g., bandwidth) capacity and status information related to the various circuits of the service provider network.

Still further, the proactive monitoring system 101 may generate a standardized audit record 107 for use in supporting subsequent analysis and presentment of current and/or expected change of status data. Under this scenario, the standardized audit record 107 may be provided as input or feedback to a requesting system of the service provider network, such as an inventory/subsystem 103a-103n management system, a validation system, or any other subsystem 103a-103n of the service provider. For example, in the case of a validation system, the standardized audit record 107 as generated may be used to determine current channel assignments and/or circuit orders for comparison against known provisioning of said circuits or channels; thus supporting validating of discrepancies pursuant to the provisioning of assets.

As another example, the standardized audit record 107 may be presented to a user interface of the proactive monitoring system 101 for indicating a current or expected state, modality, function, or disposition of various assets/subsystems 103a-103n pursuant to one or more executions/transactional occurrences. Under this scenario, the user interface may provide real-time, accurate feedback (e.g., a dashboard view) to the service provider for supporting immediate response to determined errors or proactive monitoring of the disparate subsystems 103a-103n.

It is noted therefore, that system 100 may support various immediate (e.g., real-time or near real-time) executions of the network, including error handling, exception processing, inventory/asset/subsystem 103a-103n status analysis and monitoring, predictive management and capacity/allocation scheduling, etc. Furthermore, the system 100 may support automation of the above described executions (e.g., automatic error correction, exception verification, circuit order allocation) based on the feedback provided per the standardized audit record 107. Hence, the proactive monitoring system 101 may be interfaced with the various subsystems 103a-103n of the service provider for enabling dynamic system integration and workflow processing.

For the purpose of illustration herein, the assets or inventory of the network may include various subsystems 103a-103n. FIG. 1B is a diagram of a proactive monitoring system for interacting with one or more subsystems of a service provider network, according to one embodiment. As depicted, the sub-systems 103a-103n may include, for example, a validation system 119. The validation system 119 may be configured to receive data from the proactive monitoring system 101 for validating the status of other subsystems 103a-103n, validating exceptions or discrepancies per the provisioning of assets, etc. In addition, the sub-systems 103a-103n may also include a plurality of different provisioning systems 121 and 123, including a physical or logical provisioning system respectively. Still further, the subsystems 103a-103n may include an engineering system 125, a field dispatch system 127, a procurement system 129, a trouble ticket system 130, a finance/accounting system 131, and a billing system 133.

By way of example, the provisioning systems 121 and 123 may be employed for affecting and/or carrying out orders, activating or deactivating circuits and assigning or releasing channels and deploying limited bandwidth. In addition, the proactive monitoring system 101 generates an audit record based on the change of status data. It is noted that provisioning function can also address end-to-end connectivity, and assigning equipment, paths, circuit identifiers, network addresses (e.g., Internet Protocol (IP) addresses) and customer numbers.

The physical provisioning system 121, according to one embodiment, monitors and controls the provisioning of various network resources to particular customers, such as by designing physical circuits that need to be placed in the field. Physical provisioning system 121 stores information about the circuits and their design, about various network elements, customers using the circuits, circuit bandwidth and the like. The logical provisioning system 123 can address OSI (Open System Interconnection) Layer ⅔ provisioning. As such, system 123 assigns and activates logical ports, assigns Internet Protocol (IP) ranges and addresses, and the like.

The engineering system 125 can support the functions of the engineering group. For example, the engineering group has responsibility for conduit runs, buildings, equipment, equipment bays, optical fibers within underground ducts, telephone poles, radio base stations, etc. With respect to these assets, the engineering group is also concerned with engineering limitations, environmental factors, and geospatial horizontal and vertical coordinates of equipment. Accordingly, engineering system 125 can track and store data relating to these equipment and concerns.

The field dispatch system 127 operates in conjunction with the proactive monitoring system 101 to coordinate the dispatch of technicians to address outages and equipment failure, for example, as well as the provisioning systems 121 and 123 to perform any necessary installations. In particular, dispatch system 127 may monitor and control allocation of workforce to perform various tasks needed to provide customers with various services, such as set-up and maintenance of customer's services with respect to placed orders.

In addition, a procurement system 129 can be utilized by the service provider to coordinate with other service providers and/or equipment manufacturers to acquire assets. Finance/accounting system 131 provides financial planning and analysis support of the network and services. Furthermore, the finance/accounting system 131 is involved in asset management, for example, to the extent that monies relating to the procurement of equipment and services need to be accurately accounted for and suppliers need to be paid. Billing system 133 provides invoicing capability for the services and/or products provided by the service provider network 109 to customers. For instance, billing system 133 performs the following activities: account activation and tracking, service feature selection, selection of billing rates for specific calls, invoice creation, payment entry and management of communication with the customers.

It is recognized that one or more of these systems 119-133 can be utilized, as well as additional systems, depending on the particular requirements of the service provider. Furthermore, the functionality of the sub-systems may vary with the service provider. For the purpose of illustration, a monitoring system 105 and various provisioning systems 106 (e.g., off-net provisioning tools) are shown separately. It is noted, however, that these too may be included as the various sub-systems 103a-103n.

In certain embodiments, the proactive monitoring system 101 is configured to proactively acquire data related to a change of status of said sub-systems 103a-103n from across different layers of the network relative to different transaction classifications. The different layers of the network may correspond to any known network communication models, classifications and/or protocols, including a physical layer, a network layer, a frame relay layer, a transport layer, or a combination thereof. By capturing data at multiple levels of the network, the proactive monitoring system 101 monitors the assets in a comprehensive manner. This also enables the proactive monitoring system 101 to render feedback data, i.e., audit data to a validation system of the service provider, for reconciling discrepancies or other errors more readily across the network. It is noted the audit record may be generated in accordance with a standardization procedure to ensure uniformity of the feedback data regardless of the requirements of the different assets. By way of example, the monitoring system 101 is able to acquire data regarding a change of status of the physical asset itself (e.g., a current operational mode of a subsystem 103a), data regarding the connectivity of said assets/subsystems 103a-103n (e.g., the interconnections between nodes within the network), data regarding the transport/delivery of data between subsystems 103a-103n, etc.

In another embodiment, the proactive monitoring system 101 is able to monitor different classes of transactions that occur within the network as a result of the provisioning of assets (e.g., subsystems 103a-103n). By way of example, the proactive monitoring system 101 employs a data model 105, which defines a minimal set of data types for representing one or more classifications of transactions that may occur with respect to the network. This includes scheduled transactions, which are those scheduled in advance to be performed within the network as well as unscheduled transactions, which are not scheduled to be performed per a standard workflow procedure or business processing rule of the network provider. As an example of a scheduled transaction, the proactive monitoring system 101 may collect change of status data in response to execution of a data refresh cycle set to occur every X hours. As an example of an unscheduled transaction, the proactive monitoring system 101 may acquire change of status data regarding an impromptu maintenance procedure performed with respect to a circuit.

Still further, the data model 105 may also define data types for representing on-network or off-network transaction classifications. By way of example, an off-network transaction is one that may occur while the asset is functionally disconnected from the network. An example of such a transaction is one where the subsystem 103a-103n is undetectable as a result of being powered down, physically removed from a network connection, set to offline status, etc. An example of an off-network transaction may include a manual adjustment or maintenance procedure performed by the provider of the network to a circuit or other subsystem 103a-103n.

In one embodiment, the proactive monitoring system 101 collects various types of change of status data based on the data model 105. The change of status data may include circuit order information (e.g., information regarding a parent or child tier provisioning of circuits), channel information (e.g., information regarding the provisioning of channels), capacity information (e.g., information regarding the allocation of network bandwidth), status information (e.g., information regarding the current or future status of provisioned circuits), or a combination thereof. It is noted that the above described data types may correspond to, or vary across, one or more layers of the network, one or more transaction classifications, or a combination thereof. Table 1 below presents various data types corresponding to first layer transactions (e.g., the physical layer) of the network.

TABLE 1

| Transaction Data Group | Field Name | Field Description |
|---|---|---|
| PARENT CIRCUIT ORDER | TRANSACTION_TYPE | PARENT CIRCUIT |
| DATA | | ORDER |
| PARENT CIRCUIT ORDER | OWNING_SYSTEM | Order Owning System |
| DATA | | Name |
| PARENT CIRCUIT ORDER | ORDER_NUMBER | System Order Number |
| DATA | | |
| PARENT CIRCUIT ORDER | ORDER_VERSION | System Order Version |
| DATA | | |
| PARENT CIRCUIT ORDER | ORDER_TYPE | System Order Type |
| DATA | | |
| PARENT CIRCUIT ORDER | SERVICE_TYPE | System Service Type |
| DATA | | |
| PARENT CIRCUIT ORDER | PARENT_CIRCUIT_ID | System Circuit ID |
| DATA | | |
| PARENT CIRCUIT ORDER | ORDER_STATUS | System Order Status |
| DATA | | |
| PARENT CIRCUIT ORDER | SERVICE_BWIDTH | Service Bandwidth |
| DATA | | Digital Signal 1 (DS1), |
| | | Digital Signal 2 (DS2), |
| | | etc. |
| PARENT CIRCUIT ORDER | DATE-TIME STAMP | Transaction Date- |
| DATA | | Timestamp |
| PARENT CIRCUIT ORDER | E2EI_INDICATOR | Service Instance ID |
| DATA | | |
| PARENT CIRCUIT ORDER | PON | Access Service Request |
| DATA | | (ASR)/Local Service |
| | | Request (LSR) |
| | | Purchase Order |
| | | Number |
| PARENT CIRCUIT ORDER | PON_VER | ASR-LSR Purchase |
| DATA | | Order Number Version |
| PARENT CIRCUIT ORDER | EC_SEQ | Exchange Carrier |
| DATA | | Sequence |
| PARENT CIRCUIT ORDER | ASR_ACT | ASR Activity |
| DATA | | |
| PARENT CIRCUIT ORDER | ASR_SUPP | ASR SUPPORT |
| DATA | | Number |
| PARENT CIRCUIT ORDER | ICSC_ID | Interconnect Carrier |
| DATA | | Service Center ID |
| PARENT CIRCUIT ORDER | PARENT_ECCKT | Exchange Carrier |
| DATA | | Circuit ID - (ECCKT) |
| PARENT CIRCUIT ORDER | RELATED_PON | Related ASR |
| DATA | | |
| CHANNEL NUMBER & | TRANSACTION_TYPE | CHANNEL |
| STATUS DATA | | NUMBER- STATUS |
| CHANNEL NUMBER & | OWNING_SYSTEM | Circuit-Channel |
| STATUS DATA | | Owning System Name |
| CHANNEL NUMBER & | PARENT_CIRCUIT_ID | System Circuit ID |
| STATUS DATA | | |
| CHANNEL NUMBER & | CHANNEL_NUMBER | System Channel |
| STATUS DATA | | Number |
| CHANNEL NUMBER & | CIRCUIT_STATUS | System Circuit Status |
| STATUS DATA | | |
| CHANNEL NUMBER & | ASSIGNED_CIRCUIT_ID | Circuit ID assigned to |
| STATUS DATA | | the Channel |
| CHANNEL NUMBER & | CHNL_STATUS_PROCESS | Channel Assignment |
| STATUS DATA | | Process ID - Order ID |
| | | or Manual Process |
| CHANNEL NUMBER & | CHNL_STATUS_USER_ID | User ID that Assigned |
| STATUS DATA | | the Circuit to Channel |
| CHANNEL NUMBER & | REASON_CODE | System Channel Status |
| STATUS DATA | | Reason Code (when |
| | | available) |
| CHANNEL NUMBER & | BLOCK_CODE | System Channel Block |
| STATUS DATA | | Code (when available) |
| CHANNEL NUMBER & | DATE-TIME STAMP | Transaction Date- |
| STATUS DATA | | Timestamp |
| CHANNEL NUMBER & | E2EI_INDICATOR | Service Instance ID |
| STATUS DATA | | |
| CHANNEL NUMBER & | PON | ASR-LSR Purchase |
| STATUS DATA | | Order Number |
| CHANNEL NUMBER & | PON_VER | ASR-LSR Purchase |
| STATUS DATA | | Order Number Version |
| CHANNEL NUMBER & | EC_SEQ | Exchange Carrier |
| STATUS DATA | | Sequence |
| CHANNEL NUMBER & | ICSC_ID | Interconnect Carrier |
| STATUS DATA | | Service Center ID |
| CHANNEL NUMBER & | PARENT_ECCKT | Parent Circuit - |
| STATUS DATA | | Exchange Carrier |
| | | Circuit ID - ECCKT |
| CHANNEL NUMBER & | CFA | Connection Facility |
| STATUS DATA | | Assignment |
| CHANNEL NUMBER & | CHILD_ECCKT | Child Circuit - |
| STATUS DATA | | Exchange Carrier |
| | | Circuit ID - ECCKT |
| CHANNEL NUMBER & | SEC_CFA | Secondary Connection |
| STATUS DATA | | Facility Assignment |
| | | (Child Channel) |
| CHILD CIRCUIT ORDER | OWNING_SYSTEM | Order Owning System |
| DATA | | Name |
| CHILD CIRCUIT ORDER | ORDER_NUMBER | System Order Number |
| DATA | | |
| CHILD CIRCUIT ORDER | ORDER_VERSION | System Order Version |
| DATA | | |
| CHILD CIRCUIT ORDER | ORDER_TYPE | System Order Type |
| DATA | | |
| CHILD CIRCUIT ORDER | SERVICE_TYPE | System Service Type |
| DATA | | |
| CHILD CIRCUIT ORDER | CHILD_CIRCUIT_ID | System Child Circuit |
| DATA | | ID |
| CHILD CIRCUIT ORDER | ORDER_STATUS | System Order Status |
| DATA | | |
| CHILD CIRCUIT ORDER | SERVICE_BWIDTH | Service Bandwidth |
| DATA | | DS1, DS2, DS3, etc . . . |
| CHILD CIRCUIT ORDER | RELATED_ORDER | Order ID that Invoked |
| DATA | | Child Order Creation |
| CHILD CIRCUIT ORDER | RELATED_CIRCUIT | Circuit ID that the |
| DATA | | Child Circuit Extends |
| | | (same Bandwidth) |
| CHILD CIRCUIT ORDER | CHANNELIZED_CHILD | Yes (Y) Indicator that |
| DATA | | Child Circuit is also a |
| | | Parent Circuit |
| CHILD CIRCUIT ORDER | DATE-TIME STAMP | Transaction Date- |
| DATA | | Timestamp |
| CHILD CIRCUIT ORDER | E2EI_INDICATOR | Service Instance ID |
| DATA | | |
| CHILD CIRCUIT ORDER | PON | ASR-LSR Purchase |
| DATA | | Order Number |
| CHILD CIRCUIT ORDER | PON_VER | ASR-LSR Purchase |
| DATA | | Order Number Version |
| CHILD CIRCUIT ORDER | EC_SEQ | Exchange Carrier |
| DATA | | Sequence |
| CHILD CIRCUIT ORDER | ASR_ACT | ASR Activity |
| DATA | | |
| CHILD CIRCUIT ORDER | ASR_SUPP | ASR SUPPORT |
| DATA | | Number |
| CHILD CIRCUIT ORDER | ICSC_ID | Interconnect Carrier |
| DATA | | Service Center ID |
| CHILD CIRCUIT ORDER | CHILD_ECCKT | Exchange Carrier |
| DATA | | Circuit ID - ECCKT |
| CHILD CIRCUIT ORDER | RELATED_PON | Related ASR |
| DATA | | |

Other change of status data acquired by the proactive monitoring system 101 for transactions occurring at the second and third layers (e.g., network layer, frame relay layer, transport layer) is shown by way of example with respect to Table 2 below. By way of example, the change of status data may include Ethernet or permanent circuit order information (e.g., information regarding a parent or child tier provisioning of circuits), status information (e.g., information regarding the current or future status of provisioned circuits), or a combination thereof. It is noted that a permanent virtual circuit (PVC) may correspond to a provisioning of circuits within a frame relay network while an Ethernet virtual circuit (EVC) may correspond to a point-to-point/transport circuit within a frame relay network of the provider.

TABLE 2

| Transaction Data Group | Field Name | Field Description |
|---|---|---|
| EVC ORDER STATUS | TRANSACTION_TYPE | EVC ORDER STATUS |
| DATA | | |
| EVC ORDER STATUS | OWNING_SYSTEM | Order Owning System Name |
| DATA | | |
| EVC ORDER STATUS | ORDER_NUMBER | System Order Number |
| DATA | | |
| EVC ORDER STATUS | ORDER_VERSION | System Order Version |
| DATA | | |
| EVC ORDER STATUS | ORDER_TYPE | System Order Type |
| DATA | | |
| EVC ORDER STATUS | SERVICE_TYPE | System Service Type |
| DATA | | |
| EVC ORDER STATUS | EVC_ID | Ethernet Virtual Circuit ID - |
| DATA | | Layer 2 ID |
| EVC ORDER STATUS | ORDER_STATUS | System Order Status |
| DATA | | |
| EVC ORDER STATUS | SERVICE_BWIDTH | Service Bandwidth |
| DATA | | |
| EVC ORDER STATUS | TECHNOLOGY | FIBER or Time Division |
| DATA | | Multiplexing |
| EVC ORDER STATUS | DATE-TIME STAMP | Transaction Date-Timestamp |
| DATA | | |
| EVC ORDER STATUS | E2EI_INDICATOR | Service Yes (Y) or No (N) |
| DATA | | Indicator |
| EVC CIRCUITS STATUS | TRANSACTION_TYPE | EVC CIRCUITS STATUS |
| DATA | | |
| EVC CIRCUITS STATUS | OWNING_SYSTEM | Order Owning System Name |
| DATA | | |
| EVC CIRCUITS STATUS | EVC_ID | Ethernet Virtual Circuit ID - |
| DATA | | Layer 2 ID |
| EVC CIRCUITS STATUS | EVC_STATUS | Ethernet Virtual Circuit Status - |
| DATA | | Layer 2 Status |
| EVC CIRCUITS STATUS | NBR_L1_CIRCUITS | Total Number of Layer 1 |
| DATA | | Circuits Assigned to EVC |
| EVC CIRCUITS STATUS | L1_CIRCUIT_ID | Layer 1 Circuit or Fiber System |
| DATA | | ID |
| EVC CIRCUITS STATUS | L1_CIRCUIT_STATUS | Layer 1 Circuit or Fiber System |
| DATA | | Status |
| EVC CIRCUITS STATUS | EVC_STATUS_PROCESS | Circuit Assignment Process ID - |
| DATA | | Order ID or Manual Process |
| EVC CIRCUITS STATUS | EVC_STATUS_USER_ID | User ID that Assigned the |
| DATA | | Circuit to the EVC |
| EVC CIRCUITS STATUS | EVC_CUST_END_SITE_ID | Customer Facing End EVC Site |
| DATA | | ID |
| EVC CIRCUITS STATUS | EVC_L2_SWX_SITE_ID | EVC Layer 2 SWITCH Site ID |
| DATA | | |
| EVC CIRCUITS STATUS | EVC_L3_SWX_SITE_ID | EVC Layer 3 SWITCH Site ID |
| DATA | | |
| EVC CIRCUITS STATUS | DATE-TIME STAMP | Transaction Date-Timestamp |
| DATA | | |
| EVC CIRCUITS STATUS | E2EI_INDICATOR | Service Yes (Y) or No (N) |
| DATA | | Indicator |
| PVC ORDER STATUS | TRANSACTION_TYPE | PVC ORDER STATUS |
| DATA | | |
| PVC ORDER STATUS | OWNING_SYSTEM | Order Owning System Name |
| DATA | | |
| PVC ORDER STATUS | ORDER_NUMBER | System Order Number |
| DATA | | |
| PVC ORDER STATUS | ORDER_VERSION | System Order Version |
| DATA | | |
| PVC ORDER STATUS | ORDER_TYPE | System Order Type |
| DATA | | |
| PVC ORDER STATUS | SERVICE_TYPE | System Service Type |
| DATA | | |
| PVC ORDER STATUS | PVC_ID | System Permanent Virtual |
| DATA | | Circuit ID |
| PVC ORDER STATUS | ORDER_STATUS | System Order Status |
| DATA | | |
| PVC ORDER STATUS | SERVICE_BWIDTH | Service Bandwidth |
| DATA | | |
| PVC ORDER STATUS | TECHNOLOGY | FIBER or Time Division |
| DATA | | Multiplexing |
| PVC ORDER STATUS | DATE-TIME STAMP | Transaction Date-Timestamp |
| DATA | | |
| PVC ORDER STATUS | E2EI_INDICATOR | Service Yes (Y) or No (N) |
| DATA | | Indicator |
| PVC CIRCUITS STATUS | TRANSACTION_TYPE | PVC CIRCUITS STATUS |
| DATA | | |
| PVC CIRCUITS STATUS | OWNING_SYSTEM | Order Owning System Name |
| DATA | | |
| PVC CIRCUITS STATUS | PVC_ID | Permanent Virtual Circuit ID - |
| DATA | | Layer 3 ID |
| PVC CIRCUITS STATUS | PVC_STATUS | Permanent Virtual Circuit |
| DATA | | Status - Layer 3 Status |
| PVC CIRCUITS STATUS | DLCI_IN | Data Link Control Identified |
| DATA | | (DLCI) to the Cloud |
| PVC CIRCUITS STATUS | DLCI_OUT | Data Link Control Identified |
| DATA | | (DLCI) From the Cloud |
| PVC CIRCUITS STATUS | EVC_ID | Ethernet Virtual Circuit ID - |
| DATA | | Layer 2 ID |
| PVC CIRCUITS STATUS | L1_CIRCUIT_ID | Layer 1 Circuit ID when not |
| DATA | | Ethernet Access |
| PVC CIRCUITS STATUS | PVC_STATUS_PROCESS | PVC Assignment Process ID - |
| DATA | | Order ID or Manual Process |
| PVC CIRCUITS STATUS | PVC_STATUS_USER_ID | User ID that Assigned the PVC |
| DATA | | to the EVC |
| PVC CIRCUITS STATUS | PVC_CUST_END_SITE_ID | Customer Facing End PVC Site |
| DATA | | ID |
| PVC CIRCUITS STATUS | PVC_L3_SWX_SITE_ID | PVC Layer 3 SWITCH Site ID |
| DATA | | |
| PVC CIRCUITS STATUS | DATE-TIME STAMP | Transaction Date-Timestamp |
| DATA | | |
| PVC CIRCUITS STATUS | E2EI_INDICATOR | Service Yes (Y) or No (N) |
| DATA | | Indicator |

As noted previously, the change of status data types shown in Tables 1 and 2 represent the minimal types required to support monitoring and auditing of the various subsystems 103a-103n by the proactive monitoring system 101. This change of status data is collected/stored in the native system format accordingly (e.g., to a local database of the subsystem 103a-103n). Under this scenario, the change of status data may be compiled into a local audit record (e.g., populate an audit table) then used to generate a standardized audit record 107 for reflecting the status of the system independent of the transaction classification. It is noted that an audit record may be compiled based on an audit schema corresponding to at least one of the data models 105.

In one embodiment, a trigger mechanism 108a-108n such as a stored procedure or application programming interface (API), initiates generation of the local audit record. For example, the proactive monitoring system 101 may be configured to execute or load the trigger mechanism 108a-108n in association with the subsystem 103a-103n. This may include, for example, loading the trigger mechanism 108a-108n during initial registration of the subsystem 103a-103n. The trigger mechanism 108a-108n is activated only when change of status data is committed to be stored to the local/native database of the system (e.g., for creation of a local audit record). By way of this approach, the change of status data is insulated from the occurrence of transactions that could alter the data. Hence, the trigger mechanism 108a-108n automatically generates a local audit record in response to an insert or update procedure being called by the asset for storing current change of status information. Immediate generation of the local audit record ensures that it reflects the most recent and accurate data for representing a current change of status for an asset.

In one embodiment, the proactive monitoring system 101 receives or acquires the audit record from the local system to generate a standardized audit record 107. The standardized audit record 107 is generated immediately after, or subsequent to, generation of the local audit record of the subsystem 103a-103n. By way of example, the trigger mechanism 108a-108n may transmit a signal to the proactive monitoring system 101 for indicating completion/compilation of a local audit record for a given subsystem 103a-103n. Once received, the proactive monitoring system 101 then processes the local audit record per a standardization schema to generate the standardized audit record 107.

In one embodiment, the standardization schema may specify one or more data parity rules, data mapping schemes or the like for associating and representing different data types of the disparate subsystems 103a-103n. As such, the standardized audit data 107 may represent a minimum set of data types, as expressed in a common format, for indicating the change of status of the various subsystems 103a-103n. Also, in accordance with the schema, one or more standardization procedures may be performed against the audit record, including data mapping, data cleansing, transformation and other processing techniques. The resulting standardized audit record 107 is representative of a coordinated, generalized data set that accounts for the various data types, requirements, nuances and similarities of the respective systems 106.

One advantage of the proactive monitoring system 101 is that it facilitates non-invasive data collection at the respective subsystems 103a-103n. For the purpose of illustration herein, this refers to means of data acquisition and audit generation wherein the change of status data is collected without restrictions or dependencies on the processes/transactions that cause the changes. As such, the standardized audit record 107 is based on native change of status data per the local audit record of the subsystem and is independent of any workflow procedures or other business processing rules. In addition, the proactive monitoring system 101 accesses change of status data regardless of the origin of the status change. This is critical to determine the cross functional impacts of the status changes and ultimately the root causes of any exceptions or errors.

As an example, the standardized audit record 107 may be retrieved and subsequently processed by a validation system 119 or any other system capable of interacting with the proactive monitoring system 101 for determining the current or expected status of a given subsystem 103a-103n. As such, the validation system 119 is able to anticipate an expected status of orders, circuits and channels associated with a given subsystem 103a-103n. In addition, the standardized audit record 107 can be analyzed to identify status exception conditions as well as determine any discrepancies between change of status data and a provisioning of a given subsystem 103a-103n.

As another advantage, the standardized audit data 107 provides the data required for the validation system 119, provisioning system 121 or 123, or other subsystem 103a-103n to monitor the status of multiple system orders, circuits and channels simultaneously across multiple transaction types and layers. For example, the standardized audit data 107 may account for service delivery processes, inventory management processes, field maintenance processes and other procedures that impact the order status, circuit status or channel status of respective subsystems 103a-103n. As noted, the proactive monitoring system 101 collects only the key, minimal data types required for generation of the standardized audit data 107 for such transactions.

In addition, the proactive monitoring system 101 may be configured to recognize a relationship between the various circuit order processing cycles and the impacts of various transaction types on said circuit orders as performed across different layers. For example, when a service order or access service request is initiated, the proactive status monitoring system 101 may reference requirements data regarding said transaction to determine the expected processing cycle for fulfillment of the request. Under this scenario, it is expected that the circuit order status should change between an Active and a Disconnect status. Also, depending on the system in question, the circuit status can transition to several different values that are specific to the business process. Hence, the proactive monitoring system 101 may account for such changes and processing cycles.

As another advantage, the proactive monitoring system 101 may be configured to identify exceptions and errors as early in the process as possible. This enables the system 101 to notify the business process workflow system of the exception so the service provider is tasked to resolve the issue before it results in a data integrity issue. As such, the proactive monitoring system is able to present the inventory impact of the condition, such as via a dashboard and escalate the resolution if the corrective action is not promptly attended to. Other means of highlighting a determined exception may include, for example:
Sending exception notifications to a workflow system web service.
Providing an indicator (e.g., Green, Amber, Red) to represent the impact status of the current order, circuit and channel status.
Specifying a uniform resource locator (URL) that the workflow system can use to provide user access to the dashboard.
Sending email notifications to the user to address exceptions and copy the system manager.

As yet another advantage, the proactive monitoring system 101 may generate various performance reports, capacity and allocation reports, etc. In certain implementations, the dashboard as rendered to a user interface by the proactive monitoring system 101 may enable generation or viewing of such reports. It is noted that the metrics provided by the reports may include at least the following:
Inventory circuits and channels counts
Clean circuits and channels counts
Erred circuits and channel status counts
Error Types, problems and root cause reports

For illustrative purposes, the proactive monitoring system 101 is implemented as part of a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, or other suitable infrastructure to support control and signaling functions.

According to exemplary embodiments, end user devices (not shown) may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

By way of example, telecommunications services of the service provider network 109 may provide media content or communication services (e.g., voice, data, video, etc.) to various customers (or subscribers) via customer system ₁ . . . customer system _{N}. The customers can be individuals (or residences) that receive one or more media services from the service provider network 109, either directly or from a content provider via the service provider network 109. The customer could also be an entity, such as a corporation, enterprise, or organization, that receives one or more media services from the service provider network 109, either directly or from a content provider or via the service provider network 109. The various communication conduits used to provide one or more media services to the various customers are not expressly depicted in FIG. 1, and can include the use of any form of wired or wireless communication architecture (e.g., land-line, cable, fiber optic, satellite-based, cellular, or other communication architecture).

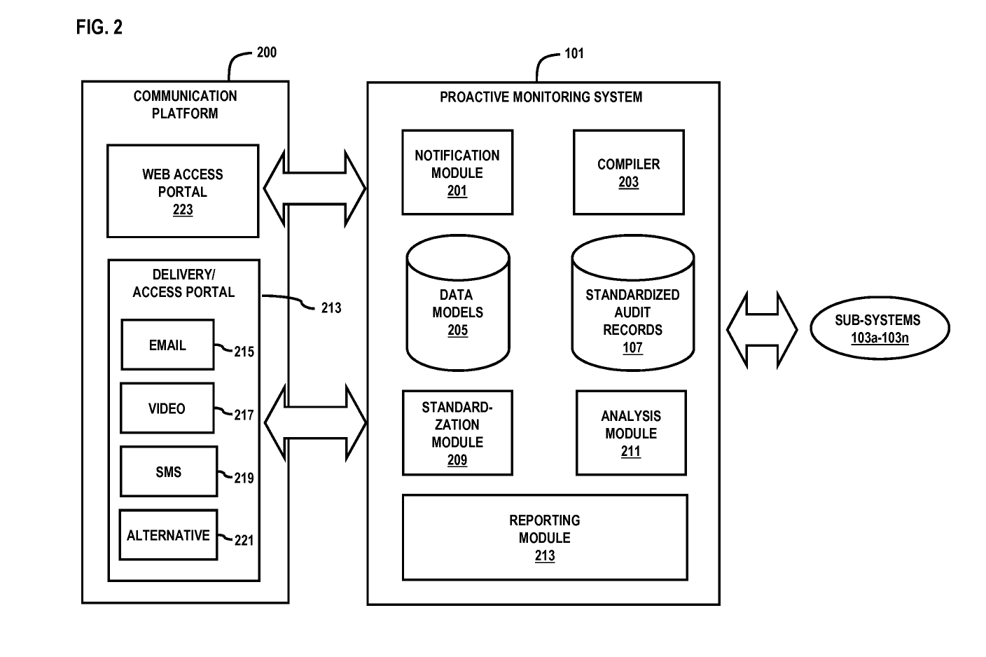

FIG. 2 is a diagram of a proactive monitoring system of FIG. 1, according to one embodiment. The proactive monitoring system 101 includes a notification module 201, which can either be integrated as part of the system 101 or may be a separate unit there from, a compiler module 203, a data model database 205, a channel analysis database 107, a standardization module 209, an analysis module 211, and a reporting module 213.

In one embodiment, the notification module 201 is configured to receive a notification signal from a trigger mechanism 108a-108n of a given asset. The notification signal may include a notice that a local audit record has been generated for a given subsystem 103a-103n. As such, the proactive monitoring system 101 is made aware that change of status data related to the subsystem 103a-103n is available. The notification module 201 may also analyze timestamp information associated with the notification signal for determining to trigger execution of a standardized audit report pertaining to the asset. In certain instances, the standardized audit report may be generated immediately, while in other instances, may be set to be generated according to a service provider defined periodicity, based on the availability of additional local audit records from other subsystems 103a-103n, etc. Generation of the standardized audit record corresponds to initiation of the compiler 203 and standardization module 209.

Still further, the notification module 201 may coordinate the integration of user interface views, including a dashboard view for facilitating the presentment of notifications, status details, etc. As such, various notification messages, requests, recommendations and instructions generated per execution of the analysis module 211 in response to the generation of standardized audit data can be rendered to a user interface of the service provider.

In one embodiment, the compiler 203 interfaces with the various active subsystems 103a-103n to gather audit data as generated based on change of status data. By way of example, the compiler 103 may initiate the required handshakes, permissions and data exchange protocols relative to the particular requirements of the subsystem for facilitating the gathering of said audit data. This exchange may be performed, for example, between the compiler 203 and the trigger mechanism 108a-108n of a given subsystem 103a-103n. The compiler 203 may be configured, i.e., at the discretion of the service provider, for enabling on-demand data acquisition or periodic data acquisition. It is noted, in certain implementations, that change of status data generated by the monitoring system 101 may also be directly compiled.

In one embodiment, the standardization module 209 processes the data gathered by the compiler 203 against various data mapping, data cleansing, transformation and other techniques to generate a standardized audit record. The compiled standardized audit record corresponds to a minimal data set required for depicting change of status data across multiple different subsystems 103a-103n and multiple different layers of the network enabling analysis and processing of the record. Hence, the resulting standardized collection is representative of a coordinated, generalized data set that accounts for the various data types, requirements, nuances and similarities of the respective subsystems 103a-103n.

In one embodiment, an analysis module 211 processes the standardized audit record 107 to determine the current status of the subsystems 103a-103n, discrepancies in the provisioning of assets, error conditions, exception conditions, or the like. By way of example, the analysis module 211 may access one or more rules or requirements data for determining a discrepancy between an expected procedure and the gathered change of status data reflected in the audit record. By way of example, the analysis module 211 may be configured, as a result of the analysis, to render a validity or invalidity result in response to a comparison of change of status data against known provisioning of the assets. In addition, the analysis module 211 may operate in connection with the notification module 201 to enable generation of one or more notification messages, i.e., message prompts, for rendering the audit record, discrepancy status, root cause analysis results, etc. It is noted that the analysis module 211 and notification module 201 may operate in connection with the communication platform 200 to render a dashboard view for presenting change of status data, audit records, etc.

In one embodiment, the reporting module 213 generates reports for indicating current and historical status information, current and historical provisioning data, change of status data and various metrics regarding the current state of the service provider network and the various assets thereof. The reporting module 213 may be customized by a user to automatically generate reports according to a predetermined frequency or in accordance with a specified format. In addition to generating reports, the reporting module 213 operates in connection with the notification module 201 to enable the rendering of notification messages, instructions and other communiqué for review by the user per execution of a validation. Still further, the reporting module 213 may operate in connection with the communication platform 200, for enabling the rendering and exchange of data with a user or manager of the various sub-systems 103a-103n of the service provider network 109.

The reporting module 213 may also be configured to provide the standardized audit record or select data elements thereof to the various subsystems 103a-103n upon request. By way of example, the audit record may be provided to a network management system or provisioning system of the provider for supporting up-to-date allocation of inventory across the network. As another example, expected change of status information may be provided to a maintenance system for enabling the automatic generation of ticket orders regarding layer 1 system issues.

The communication platform 200 is provided to allow for automated status and notification messages to be sent. Such messages can be presented either as a one way communication or in an interactive manner so that a receiving system is given an ability to communicate further information to the proactive monitoring system 101 and/or to request and retrieve additional information (e.g., using web links, or telephone menus, email addresses, etc.).

The communication platform 200 includes a delivery/access portal 213 having an email portal 215, a video portal 217, an SMS portal 219 an alternative portal 221 for using any alternative manner of communication. The communication platform 200 also includes a web access portal 223. The communication platform 200 allows the proactive monitoring system 101 to automatically send change of status, inventory discrepancy and status summary updates as required, and/or permits proactive access and retrieval of reports as required by the requesting subsystems 103a-103n. The information may be presented via the web access portal 223 in web form, such that the reports and other data may be viewed by way of a web portal or browser For example, upon updating of the audit record 107, the notification module 201 could direct a web communication to a web address of another of subsystems 119-133 to obtain further information relating to a detected asset discrepancy, or to obtain historical data relating to the discrepancy status, etc.

Still further, the communication platform 200 may support the authentication and/or registration of the various assets/subsystems 103a-103n for interaction with the proactive monitoring system. This may include, for example, establishing a network location, inventory profile, inventory identification and other relevant descriptors association with registration profile information maintained by the proactive monitoring system 101. Per this implementation, the web access portal 223 may further enable generation of a registration interface for supporting the configuration of assets for interaction with the proactive monitoring system 101. This may include, for example, enabling the loading of trigger mechanisms 108a-108n to the various subsystems 103a-103n. In addition, the service provider may establish a frequency at which feedback data is to be provided to the subsystems 103a-103n based on the standardized audit reports 107. It is noted that a dashboard view or other means of presenting the audit records, metrics or reports may be incumbent upon proper registration of the asset with the proactive monitoring system 101.

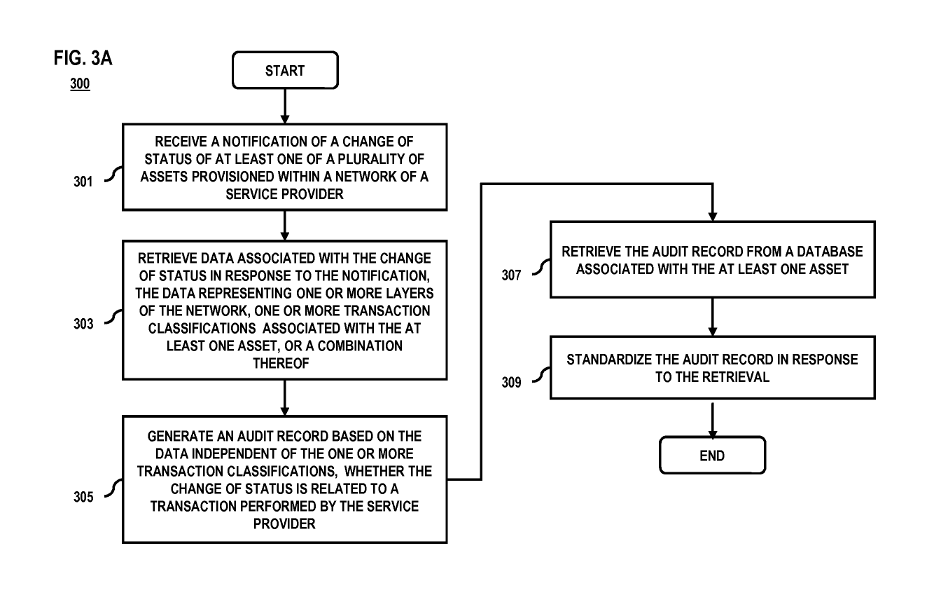

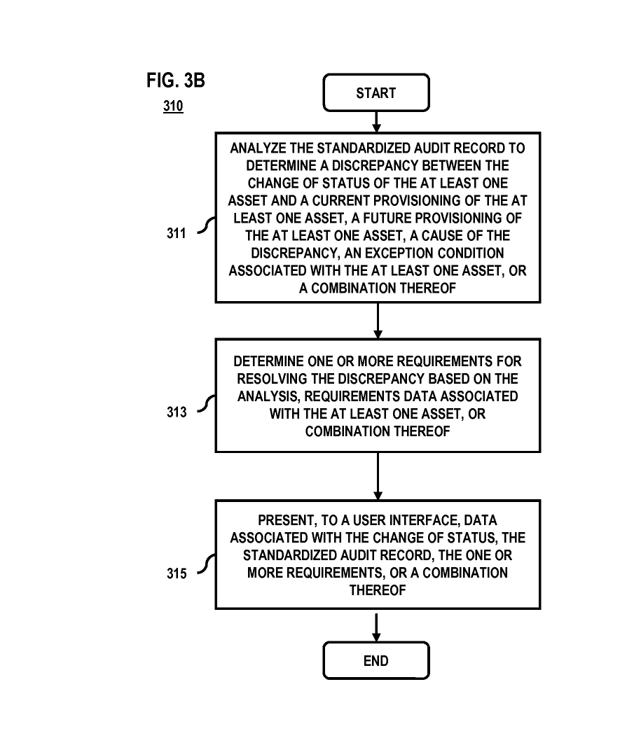

FIGS. 3A and 3B are flowcharts of a process for enabling a monitoring system to immediately identify different types of transactions that occur within a service provider network, according to various embodiments. In one embodiment, the proactive monitoring system 101 performs processes 300 and 310 in connection with the trigger mechanisms of the various subsystems.

In step 301, the proactive monitoring system 101 receives a notification of a change of status of at least one of a plurality of assets provisioned within a network of a service provider. As noted previously, the notification may be transmitted to the proactive monitoring system 101 by a trigger mechanism 108 of a given subsystem 103 in response to generation of change of status information.

In another step 303, the proactive monitoring system 101 retrieves data associated with the change of status in response to the notification, the data representing one or more layers of the network, one or more transaction classifications associated with the at least one asset, or a combination thereof. As noted previously, the one or more layers correspond to a physical layer, a network layer, a frame relay layer, a transport layer, or a combination thereof. Moreover, the one or more transaction classifications may include a scheduled transaction, an unscheduled transaction, an on-network transaction, an off-network transaction, or a combination thereof. In another step 305, the proactive monitoring system 101 generates an audit record based on the data independent of the one or more transaction classifications, whether the change of status is related to a transaction performed by the service provider, or a combination thereof.

In another step 307, the proactive monitoring system 101 retrieves the audit record from a database associated with the at least one asset. The database may include a local database that is immediately accessible to the asset and the retrieval is performed independent of whether the change of status is related to a transaction performed by the service provider. As mentioned previously, immediate storing of the audit record at the local database of the asset supports near-real time storage of change of status information prior to/independent of any adaptation of the change of status information due to performance of a transaction. Per step 309, the proactive monitoring system 101 then standardizes the audit record in response to the retrieval. As noted, the standardization may be performed according to any known standardization models or techniques.

In step 311 of process 310 (FIG. 3B), the proactive monitoring system 101 analyzes the standardized audit record to determine a discrepancy between the change of status of the at least one asset and a current provisioning of the at least one asset, a future provisioning of the at least one asset, a cause of the discrepancy, an exception condition associated with the at least one asset, or a combination thereof. In another step 313, the proactive monitoring system 101 determines one or more requirements for resolving the discrepancy based on the analysis, requirements data associated with the at least one asset, or combination thereof. Still further, per step 315, the proactive monitoring system 101 presents, to a user interface, data associated with the change of status, the standardized audit record, the one or more requirements, or a combination thereof. As noted previously, this information may be presented as a dashboard that is accessible to the service provider for supporting real-time change of status information.

It is noted that the above described executions correspond to a closed loop feedback procedure, wherein the various subsystems 103 that interact with the proactive monitoring system 101 may be continually provided up-to-date audit data. Based on this feedback, circuit order, channel status or other elements/assets of the network system may be continually refined to increase the rate at which discrepancies are identified and resolved. This is in contrast to traditional approaches to asset monitoring, wherein the change of status data is not immediately available to the service provider nor is it reflective of all transaction classifications that may occur (e.g., on-network and off-network).

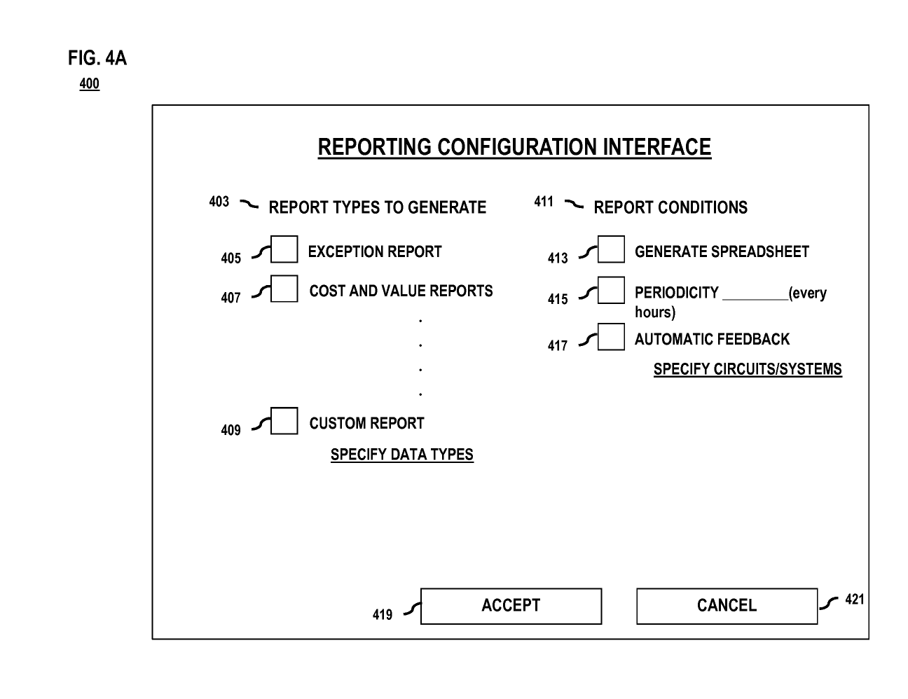

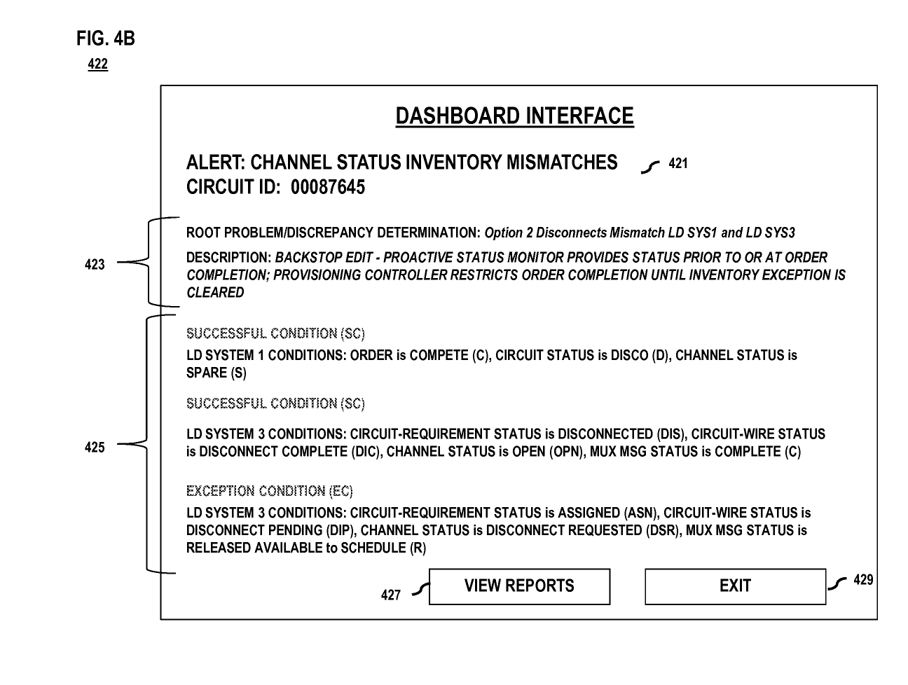

FIGS. 4A and 4B are diagrams of user interfaces rendered by the system of FIGS. 1A and 1, according to various embodiments. For the purpose of illustration, user interface 400 corresponds to a reporting configuration interface for establishing the reporting execution of the proactive monitoring system 101. User interface 422 corresponds to a dashboard interface for presenting standardized audit information related to a given subsystem, i.e., root cause information, error conditions, etc. It is noted that various other user interface executions may be generated and rendered by the proactive monitoring system 101.

In FIG. 4A, the user (e.g., a representative of the service provider) may be presented with various report types to capable of being generated. For example, the user may select various checkboxes 405-409 for generating exception reports related to a specific subsystem, cost and value reports related to a specific subsystem, custom reports related to specific subsystems, etc. The reports may be customized based on the various data types collected per the standardized audit generation procedure at the discretion of the user. In addition, the reporting metrics may be defined by the user for enabling specific reporting. For example, a success and exception report may be based on volume (of data, or system provisioning, etc.) for enabling the establishing of one or more key performance indicators (KPIs). As another example, the cost and value reports may be based on success and exception condition durations.

Still further, the user may establish their preferred report conditions 411. For example, the user may select one or more checkboxes 413-417 for defining the characteristics, features or conditions of the report. This may include an option for generating the report as a spreadsheet, flat file or in accordance with another format. As another example, the user may establish a periodicity of report generation for a given subsystem. Still further, the user may opt to enable automatic feedback of specific subsystems. Once the user options are selected, the user may activate the options by selecting the ACCEPT option button 419. Alternatively, the user may select the CANCEL option button 421 to cancel the selections.

In FIG. 4B, the dashboard interface 422 may be presented to a display of the service provider in response to a determined change of status of a given subsystem. For example, the alert type and circuit identifier to which the alert corresponds is presented for identifying the source of the alert. In this example, the alert is related to a channel status inventory mismatch. Also presented to the display is a root problem statement and description statement 423 for indicating a root cause of the mismatch. The description statement may also present various descriptors and/or root cause determinants. It is noted that the descriptors, determinants and other factors leading to the root cause may be based on analysis of the standardized audit record. In addition, various requirements data associated with the subsystem in question is also analyzed for generating a root cause determination.

The dashboard 425 may also present various success conditions and exception conditions for providing the user with additional conditions upon which the root cause determination is based. For example, the exception condition may specify a disconnection status is associated with the specified circuit or that the circuit is released/available for scheduling. It is noted that multiple variations of the success and/or exception conditions may be presented.

The processes described herein for identifying different types of transactions that occur within a service provider network may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

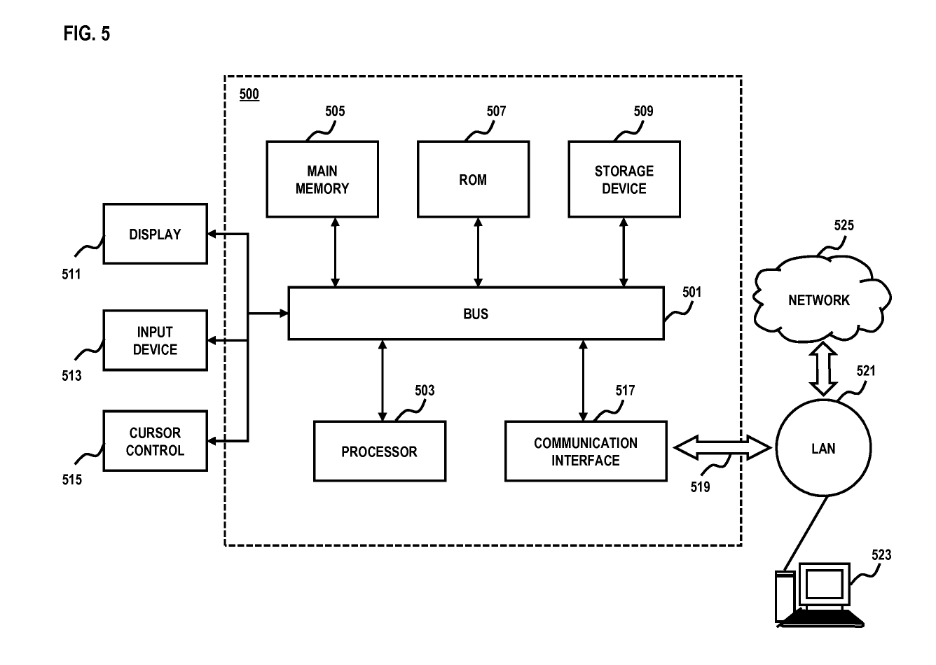

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIGS. 4A and 4B, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

1. A method comprising:
receiving a notification of a change of status of at least one asset provisioned within a network of a service provider;
retrieving data associated with the change of status in response to the notification, the data representing one or more layers of the network, one or more transaction classifications associated with the at least one asset, or a combination thereof; and
generating an audit record based on (a) the data independent of the one or more transaction classifications, (b) whether the change of status is related to a transaction performed by the service provider, or (c) a combination thereof.

2. A method of claim 1, further comprising:
retrieving the audit record from a database associated with the at least one asset; and
standardizing the audit record in response to the retrieval,
wherein the database is accessible to the at least one asset and the retrieval is performed independent of whether the change of status is related to a transaction performed by the service provider.

3. A method of claim 2, further comprising:
analyzing the standardized audit record to determine a discrepancy between the change of status of the at least one asset and a current provisioning of the at least one asset, a future provisioning of the at least one asset, a cause of the discrepancy, an exception condition associated with the at least one asset, or a combination thereof.

4. A method of claim 3, further comprising:
determining one or more requirements for resolving the discrepancy based on the analysis, requirements data associated with the at least one asset, or combination thereof.

5. A method of claim 3, further comprising:
presenting, to a user interface, data associated with the change of status, the standardized audit record, the one or more requirements, or a combination thereof,
wherein the data is presented prior to completion of the transaction and the one or more transaction classifications include a scheduled transaction, an unscheduled transaction, an on-network transaction, an off-network transaction, or a combination thereof.

6. A method of claim 1, wherein the notification is triggered by a stored procedure associated with the transaction, the at least one asset, or a combination thereof, an application programming interface called in association with the transaction, the at least one asset, or a combination thereof, or a combination thereof.

7. A method of claim 1, wherein the one or more layers correspond to a physical layer, a network layer, a frame relay layer, a transport layer, or a combination thereof.

8. A method of claim 1, wherein the retrieval of the data associated with the change of status is based on a data model representing a set of data types required to generate the audit record.

9. A method of claim 8, wherein the one or more data types includes order information, circuit information, channel information, capacity information, status information or a combination thereof associated with the one or more layers of the network, the one or more transaction classifications, or a combination thereof.

10. A method according to claim 1, wherein the assets include physical circuits, sub-systems, or a combination thereof of the network of the service provider.

11. An apparatus comprising a processor configured to:
receive a notification of a change of status of at least one asset provisioned within a network of a service provider,
retrieve data associated with the change of status in response to the notification, the data representing one or more layers of the network, one or more transaction classifications associated with the at least one asset, or a combination thereof, and
generate an audit record based on (a) the data independent of the one or more transaction classifications, (b) whether the change of status is related to a transaction performed by the service provider, or (c) a combination thereof.

12. An apparatus of claim 11, wherein the apparatus is further caused, at least in part, to:
retrieve the audit record from a database associated with the at least one asset; and
standardize the audit record in response to the retrieval,
wherein the database is accessible to the at least one asset and the retrieval is performed independent of whether the change of status is related to a transaction performed by the service provider.

13. An apparatus of claim 12, wherein the apparatus is further caused, at least in part, to:
analyze the standardized audit record to determine a discrepancy between the change of status of the at least one asset and a current provisioning of the at least one asset, a future provisioning of the at least one asset, a cause of the discrepancy, an exception condition associated with the at least one asset, or a combination thereof.

14. An apparatus of claim 13, wherein the apparatus is further caused, at least in part, to:
determine one or more requirements for resolving the discrepancy based on the analysis, requirements data associated with the at least one asset, or combination thereof.

15. An apparatus of claim 13, wherein the apparatus is further caused, at least in part, to:
present, to a user interface, data associated with the change of status, the standardized audit record, the one or more requirements, or a combination thereof,
wherein the data is presented prior to completion of the transaction and the one or more transaction classifications include a scheduled transaction, an unscheduled transaction, an on-network transaction, an off-network transaction, or a combination thereof.

16. An apparatus of claim 11, wherein the notification is triggered by a stored procedure associated with the transaction, the at least one asset, or a combination thereof, an application programming interface called in association with the transaction, the at least one asset, or a combination thereof, or a combination thereof.

17. An apparatus of claim 11, wherein the one or more layers correspond to a physical layer, a network layer, a frame relay layer, a transport layer, or a combination thereof.

18. An apparatus of claim 11, wherein the retrieval of the data associated with the change of status is based on a data model representing a set of data types required to generate the audit record.

19. A system comprising:
a provisioning system configured to maintain data for indicating a current provisioning of a plurality of assets of a service provider;
a monitoring system configured to monitor a status of the plurality of assets; and
a validation system configured to standardize data provided by the monitoring system and the plurality of different provisioning systems and to validate a discrepancy between the status data and data for indicating the current provisioning of the plurality of assets,
wherein the validation system provides as feedback to the monitoring system, requirements for resolving the discrepancy.

20. A system of claim 19, further comprising:
a repository for maintaining the standardized data,
wherein the validation is based on analysis of the standardized data.
